(19) United States
(12) Patent Application Publication
(10) Pub. No.: US 2010/0309679 A1
(43) Pub. Date: Dec. 9, 2010

(54) VEHICLE HEADLIGHT

(76) Inventors: Shinji Yamagata, Tokyo (JP); Takashi Akutagawa, Tokyo (JP)

Correspondence Address: KENEALY VAIDYA LLP, 515 EAST BRADDOCK RD SUITE B, Alexandria, VA, 22314, US

(21) Appl. No.: 12/794,488

(22) Filed: Jun. 4, 2010

(30) Foreign Application Priority Data
Jun. 4, 2009 (JP) 2009-135506

(51) Int. Cl. B60Q 1/04

(52) U.S. Cl. 362/539; 362/547

(57) ABSTRACT

A projector headlight for a low beam can include a first and second lighting unit. Each of the first and second lighting units can include an LED light source, an ellipsoidal reflector, a projector lens and a shade. Light emitted from the LED light source can form a light distribution pattern from the projector lens via the ellipsoidal reflector by shielding an upwards portion of the light with the shade. The shade of the second lighting unit may be configured so as not to project light on a specific point under a cut-off line on an oncoming lane using a convex portion thereon. Therefore, the first lighting unit can project light with a maximum light intensity at the specific point so as to overlap the light distribution pattern formed by the second lighting unit. Thus, the projector headlight can perform a favorable light distribution pattern that can conform to a light distribution standard for headlights.

This application claims the priority benefit under 35 U.S.C. §119 of Japanese Patent Application No. 2009-135506 filed on Jun. 4, 2009, which is hereby incorporated in its entirety by reference.

### BACKGROUND

1. Field

The presently disclosed subject matter relates to a vehicle headlight of a projector type, and more particularly to a projector headlight including a plurality of lighting units for a low beam that can form a favorable light distribution pattern, and which can conform to a light distribution standard for a headlight.

2. Description of the Related Art

An LED has been used as a light source for a vehicle headlight, and a plurality of lighting units using the LED light source are frequently incorporated into the vehicle headlight such as a projector headlight and the like. The projector headlight may allow a light-emitting area thereof to be reduced and therefore allows the headlight to be minimized in comparison with other type headlights. In addition, when the LED light source is used as a light source for the lighting unit, a battery friendly and small projector headlight can be realized due to low consumption requirements for the device.

A projector headlight is also disclosed in Applicant's co-pending patent application, U.S. patent application Ser. No. ______, filed on same date, Jun. 4, 2010, Attorney Docket No. ST3001-0254, which is hereby incorporated in its entirety by reference.

A conventional headlight including a plurality of lighting units for a low beam is disclosed in patent document No. 1 (Japanese Patent No. 4,024,628). FIG. 7a is a schematic top view depicting a structure for the conventional headlight including a plurality of lighting units, which is disclosed in patent document No. 1. FIG. 7b is a schematic diagram showing a fundamental light distribution pattern that is formed by the conventional headlight.

According to the conventional headlight 50 shown in FIG. 7a, the vehicle headlight 50 includes: first lighting units 50a, 51a and 52a for forming a cut-off pattern Pa including a cut-off line as shown FIG. 7a; second lighting units 60b to 64b for forming a hot zone pattern Pb as shown FIG. 7a; and third lighting units 70c, 71c and 72c for forming a diffusing pattern Pc, which can illuminate a wide area. Thus, the headlight 50 can form a light distribution pattern PL for a low beam.

However, because the light distribution pattern PL is formed by the plurality of lighting units 50a-52a, 60b-64b and 70c-72c, each of the lighting units need to reduce each variation of light distribution patterns formed thereby. If each variation of the light distribution patterns becomes large, their variations may cause a problem such that a headlight using the lighting units does not conform to a light distribution standard for a headlight.

For example, according to ECE Regulation, a maximum light intensity value and a minimum light intensity value at 50 R point (0.86 D-3.43 R) on a vertical screen that is located at 25 meters away from a vehicle headlight are established in order not to produce glare for drivers in an oncoming lane.

However, in the light distribution pattern PL shown in FIG. 7b, if the hot zone pattern Pb covers the 50 P point along with the cut-off pattern Pa and the diffusing pattern Pc due to the variations when assembling parts in each of the lighting units, when assembling the light units in the headlight, etc., the light distribution pattern PL may exceed the maximum light intensity at the 50 R point. On the contrary, if the cut-off pattern Pa does not cover the 50 R point along with the diffusing pattern Pc because of the variations or if the diffusing pattern Pc does not cover the 50 R point along with the diffusing pattern Pc, a light intensity at the 50 R point on the light distribution pattern PL may fall below the minimum light intensity value.

Therefore, there is a way in which the hot zone pattern Pb keeps a slightly dark light intensity. In this case, even if the hot zone pattern Pb covers the 50 P point, the light distribution pattern PL may conform to the light distribution standard for a headlight. However, the vehicle headlight may experience decreased visibility and therefore may have a debasement or devaluation of merchantability.

The above-referenced and Patent Documents are listed below and are hereby incorporated with their English abstracts in their entirety.

1. Patent document No. 1: Japanese Patent No. 4,024,628

2. Patent document No. 2: Japanese Patent No. 2,696,745

The disclosed subject matter has been devised to consider the above and other problems, characteristics and features. Thus, an embodiment of the disclosed subject matter can include a projector headlight for a low beam having a favorable light distribution pattern that can conform to a light distribution standard for headlights with respect to a prescribed light intensity value for headlights that include a horizontal cut-off line for an oncoming lane. In this case, the projector headlight can include a first and second lighting unit using an LED light source, in which the first and second lighting units can form a whole favorable light distribution pattern while the first lighting unit can conform to the prescribed light intensity value for headlights that use the horizontal cut-off line for an oncoming lane.

### SUMMARY

The presently disclosed subject matter has been devised in view of the above and other characteristics, desires, and problems in the conventional art, and to make certain changes to existing projector headlights. Thus, an aspect of the disclosed subject matter includes providing a projector headlight for a low beam having a favorable light distribution pattern that can conform to a light distribution standard for headlights with respect to a prescribed light intensity for headlights that use a horizontal cut-off line on an oncoming lane, wherein a first and second lighting unit using an LED light source having low power consumption can perform the favorable light distribution pattern with a simple structure and the basically same structure. Another aspect of the disclosed subject matter includes providing a projector headlight including the first and second lighting units, which can achieve a battery friendly and small projector headlight using an LED light source so that it can be used for an electric car and the like.

According to an aspect of the disclosed subject matter, a projector headlight can include at least one first lighting unit and at least one second light unit that are located adjacent to each other. Each of the at least one first and second lighting units can include: an LED light source, at least one ellipsoidal reflector, a projector lens and a shade. At least the ellipsoidal reflector can have a first focus and a second focus, the first focus thereof being located near the light source. The projector lens can have both a focus curve including a focus and an optical axis thereof that is located substantially on an imaginary line connecting the first focus and the second focus of at least the one ellipsoidal reflector. The shade can comprise a neutral point located near the focus of the projector lens and a first, second and third top edge line that can be configured to form a horizontal cut-off line and an elbow line with light emitted from the light source. In addition, the third top edge line of the at least one second lighting unit can further include a fourth top edge line on the third top edge line.

In the above-described exemplary projector headlight, the fourth top edge line of the at least one second lighting unit can shield light emitted from the LED light source on a prescribed area, for example, including a point located 0.86 degrees downwards in a vertical direction and 3.43 degrees towards an oncoming lane in a horizontal direction. The focus curve of the projector lens of the at least one first/second lighting unit can correspond to substantially the second top edge line and a virtual extending line of the second top edge lines of the at least one first/second lighting unit, and each of the second focuses of the other ellipsoidal reflectors other than at least the ellipsoidal reflector of the at least one first/second lighting unit can be located substantially on the second top edge line of the shade and the virtual extending line of the second top edge line located of the at least one first/second lighting unit.

In this case, the first lighting unit can project light emitted from the LED light on the prescribed area with a perfect light intensity, and the third top edge line of the second lighting unit can shield the light on the prescribed area even if variations such as an assembly for the first and second lighting units and the like occur. Thus, the projector light can conform to a prescribed light intensity value under the cut-off line on an oncoming lane by the first lighting unit. Moreover, each of the second focuses of the other ellipsoidal reflectors other than at least the ellipsoidal reflector can be located substantially on the second top edge line of the shade and the virtual extending line of the second top edge line that are located at the focus curve of the projector lens. Thus, the projector headlight of the disclosed subject matter can form a favorable light distribution with a wide range and a simple structure.

According to another aspect of the disclosed subject matter, a projector headlight can include at least one first lighting unit and at least one second lighting unit that are located adjacent to each other. Each of the at least one first and second lighting units can include: an LED light source having an optical axis; at least one ellipsoidal reflector having a first focus and a second focus, and the first focus thereof can be located substantially at the LED light source; a projector lens having both a focus and an optical axis located substantially on an imaginary line that connects the first focus and the second focus of at least the ellipsoidal reflector, and the focus of the projector lens being located substantially at the second focus of at least the ellipsoidal reflector; a shade; and a housing attaching at least the projector lens, the shade and the at least one ellipsoidal reflector.

In the above-described projector headlight including the first and second lighting units, because the structure of the shade, the ellipsoidal reflector and the projector lens can be substantially the same, the projector headlight using the LED light source can perform the features set forth below in paragraphs [0013]-[0015]. In addition, the optical axis of the LED light source can intersect with the imaginary line of the projector lens substantially at the first focus of the at least one ellipsoidal reflector so as to corresponds to each other in a vertical direction, and an intersecting angle of the optical axis of the LED light source and the imaginary line of the projector lens towards the at least one ellipsoidal reflector can be smaller than the intersecting angle towards the projector lens.

Therefore, the projector headlight can exhibit improved faraway or distance visibility because light emitted from the LED light source can illuminate at a faraway point. Furthermore, each of the second focuses of the other ellipsoidal reflectors other than at least the ellipsoidal reflector can also be located substantially on the first top edge line of the shade and the second top edge line in order to improve light use efficiency. Thus, the disclosed subject matter can provide a small projector headlight that can perform a favorable light distribution pattern with a high efficiency and low power consumption, and which can be used for various types of vehicles, including electrical cars and the like.

### BRIEF DESCRIPTION OF THE DRAWINGS

These and other characteristics and features of the disclosed subject matter will become clear from the following description with reference to the accompanying drawings, wherein:

FIG. 1a is a top view showing an exemplary vehicle headlight for a low beam made in accordance with principles of the disclosed subject matter, and FIG. 1b is a schematic side cross-section view showing an exemplary structure of a first lighting unit and a second lighting unit included in the exemplary vehicle headlight;

FIG. 2a is a perspective view showing a shade for the first lighting unit shown in FIG. 1a and FIG. 1b, and FIG. 2b shows the shade in a front view from an arrow shown in FIG. 2a;

FIG. 3a is a perspective view showing a shade for the second lighting unit shown FIG. 1a and FIG. 1b, and FIG. 3b shows the shade in a front view from an arrow shown in FIG. 3a;

FIG. 4 is a schematic diagram showing a fundamental light distribution pattern P formed on a vertical screen that is located at a prescribed position from the exemplary vehicle headlight of FIG. 1a, wherein light distribution patterns P1 and P2 are formed by the first and second lighting units, respectively;

FIG. 5a is a schematic diagram showing the light distribution pattern P1 formed on a road by the first lighting unit, FIG. 5b is a schematic diagram showing the light distribution pattern P2 formed on a road by the second lighting unit, and FIG. 5c shows the light distribution P on a road by the vehicle headlight of FIG. 1a, wherein broken lines show light distribution patterns that are formed by a conventional structure for a headlight;

FIG. 6 is a perspective enlarged view depicting another exemplary shade for the second lighting unit; and

FIG. 7a is a schematic top view depicting a structure for a conventional headlight including a plurality of lighting units, and FIG. 7b is a schematic diagram showing a fundamental light distribution pattern formed by the conventional headlight of FIG. 7a.

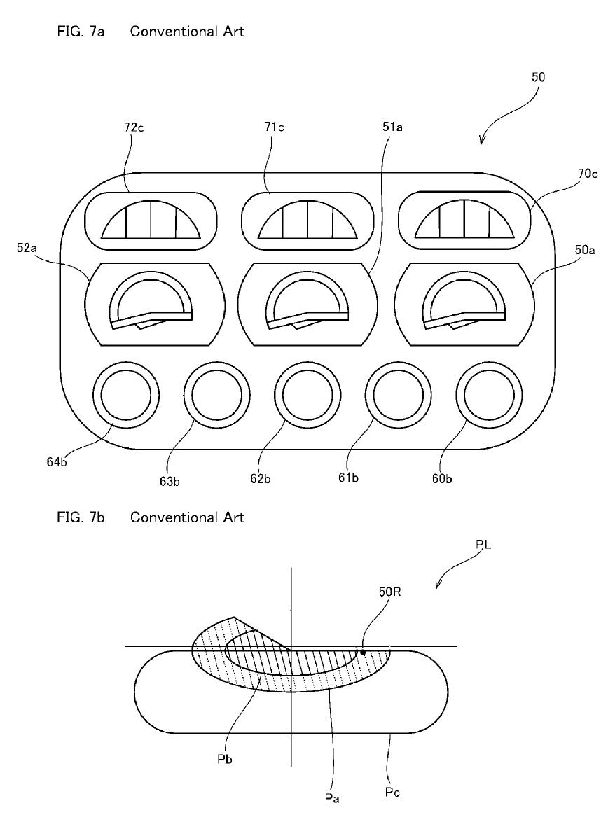

### DETAILED DESCRIPTION OF EXEMPLARY EMBODIMENTS

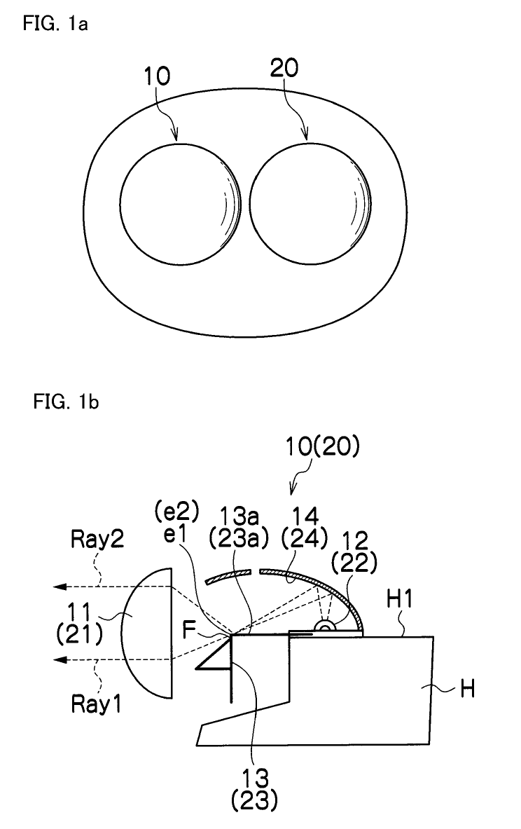

The disclosed subject matter will now be described in detail with reference to FIG. 1 to FIG. 6. FIG. 1a is a top view showing an exemplary vehicle headlight for a low beam made in accordance with principles of the disclosed subject matter, and FIG. 1b is a schematic side cross-section view showing an exemplary structure of a first and second lighting unit included in the exemplary vehicle headlight.

The exemplary vehicle headlight of FIG. 1a can include a first lighting unit 10 and second lighting unit 20 that can form a light distribution pattern P for a low beam as described later. The first lighting unit 10 can include: a projector lens 11 located in a forward direction of the vehicle headlight; an LED light source 12 located in a rearward direction of the vehicle headlight; a shade 13 located between the projector lens 11 and the LED light source 12; and a reflector 14 located in a light-emitting direction of the LED light source 12.

The projector lens 11 can have an optical axis including a focus F that is located towards the LED light source, and can be a collecting lens that is formed with an aspheric surface. The LED light source 12 can be, for example, a white LED device which is attached to a top surface H1 of a heat sink H so that an optical axis of the LED light source 12 can be perpendicular to the top surface H1 or can slant in the opposite direction of the projector lens 11. In addition, the optical axis of the LED light source 12 can correspond to the optical axis including the focus F of the projector lens 11 in a vertical direction.

The reflector 14 can be located so as to cover the LED light source 12, and can be substantially ellipsoidal having a first focus and a second focus. The first focus of the reflector 14 can be located substantially at the LED light source 12 so that light emitted from the LED light source 12 can be concentrated at the second focus of the reflector 14 after reflecting on/from the reflector 14. The second focus of the surface 14 can be located near a focus F of the projector lens 11. Thus, an optical axis of the lighting unit 10 can substantially correspond to the optical axis of the projector lens 11 including the focus F, the LED light source 12, and the first and second focuses of the reflector 14.

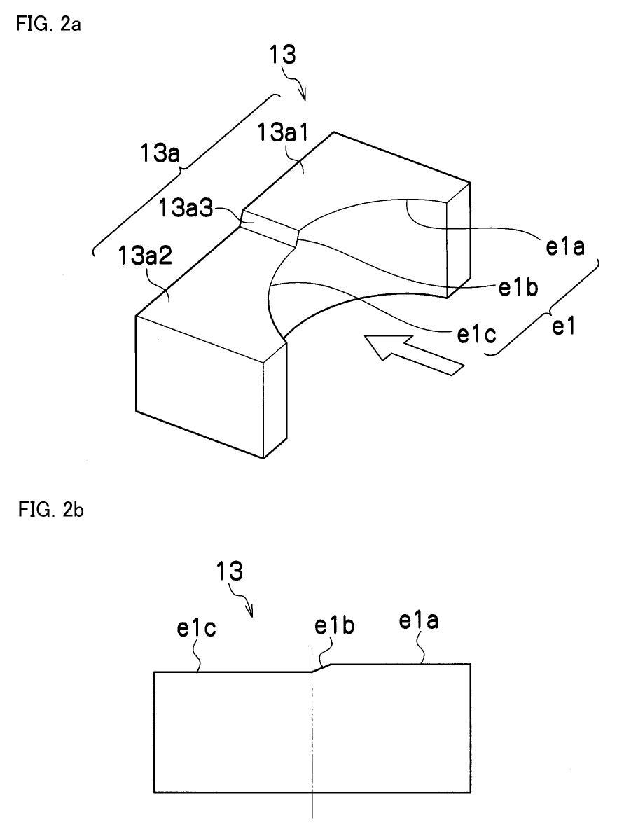

When the first lighting unit 10 is used in low beam mode using the above-described structure, the first lighting unit 10 can include the shade 13 in order to shield an upward light that may give a glaring type light to an oncoming car and the like. The shade 13 will now be described in detail. FIG. 2a is a perspective view showing the shade 13 for the first lighting unit 10 shown in FIG. 1, and FIG. 2b shows the shade 13 in a front view from an arrow shown in FIG. 2a.

The shade 13 can include a top reflex surface 13a that includes: a first top reflex surface 13a1 located and extending in a horizontal planar direction; a second top reflex surface 13a2 located and extending in a horizontal planar direction, and a virtual extending surface thereof located under the first top reflex surface 13a1 so as to be substantially parallel with the first top surface 13a1; a third top reflex surface 13a3 located between the first top reflex surface 13a1 and the second top reflex surface 13a2; and a top edge e1 located at an end of the top reflex surface 13a towards the projector lens 11.

The top edge e1 of the top reflex surface 13a of the shade 13 can include: a first top edge line e1a located at an end of the first top reflex surface 13a1 towards the projector lens 11, and can be configured to form a horizontal cut-off line on an oncoming lane; a second top edge line e1c located at an end of the second top reflex surface 13a2, which can be configured to form a horizontal cut-off line on a driving lane; and a third top edge line e1b located at an end of the third top reflex surface 13a3, which can be configured to form an elbow line between the first and second top reflex surfaces 13a1, 13a2.

In this case, the top edge e1 can be formed in a substantially circular arc shape towards the projector lens 11 in a top view of the shade 13, and can be configured to form a top line of the horizontal cut-off line. The third top reflex surface 13a3 can be determined, for example, so that the third top edge line e1b for forming the elbow line becomes a slant angle of 45 degrees with respect to the horizontal line.

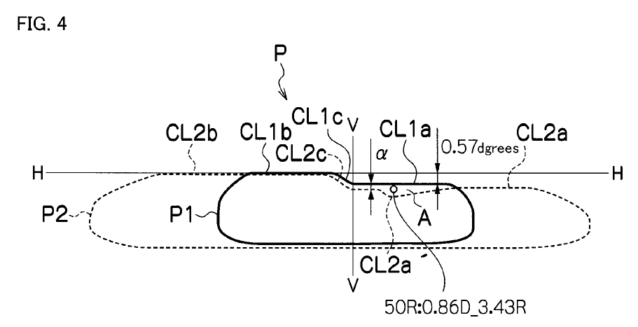

FIG. 4 is a schematic diagram showing a fundamental light distribution pattern P formed on a vertical screen that is located at 25 meters away from the exemplary vehicle headlight of FIG. 1a, wherein a light distribution pattern P1 is formed by the first lighting unit 10. As shown in FIG. 1b, light emitted from the LED light source 12 can be reflected on the reflector 14 and can concentrate at the top edge e1. Ray 1 passing through the first top edge e1 and Ray 2 being reflected at the top edge e1 can form a cut-off line CL1a, CL1b and CL1c.

In this case, the first top edge line e1a can form the cut-off line CL1a on an oncoming lane, the second top edge line e1c can form the cut-off line CL1b on a driving lane, and the third top edge line e1b can form the cut-off line CL1c of the elbow line. The light distribution pattern P1 having a relatively narrow range can be formed by the first lighting unit 10 as compared with the second lighting unit 20 described later.

The optical axis of the first lighting unit 10 can include a neutral point of the shade 13 that is located at an intersection of a virtual extending line of the second top edge line e1c and another virtual line that passes at an intersection of the first top edge line e1a and the third top edge line e1b while intersecting with the virtual extending line of the second top edge line e1c at a right angle, so that the optical axis of the first lighting unit 10 can pass through an intersection of the horizontal line H and the vertical line V shown in FIG. 4.

The second lighting unit 20 can form a light distribution pattern P2 that is outlined with a broken line as shown in FIG. 4. The light distribution pattern P2 can be formed so as to overlap the light distribution pattern P1 that is formed by the first lighting unit 10, and can be formed with a wider range as compared with the light distribution pattern P1. The second lighting unit 20 can include: a projector lens 21; an LED light source 22; a shade 23 including a top reflex surface 23a; and a reflector 24 as shown in FIG. 1b.

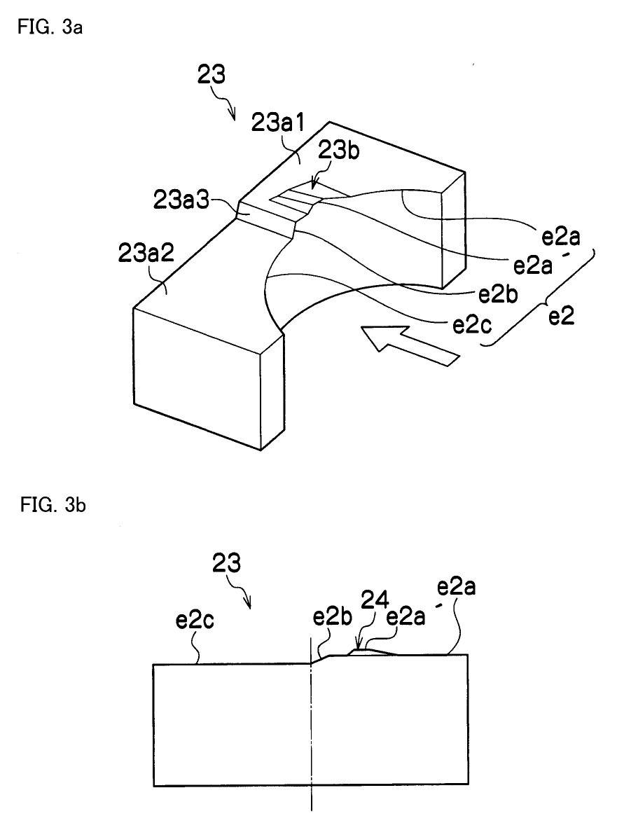

A structure of the second lighting unit 20 can be basically the same as the first light unit 10, and a main difference between the first and second lighting units 10, 20 can be the configuration of the above-described shade. Therefore, a description of the shade 23 of the second lighting unit 20 will now be given with reference to FIG. 3a and FIG. 3b. FIG. 3a is a perspective view showing the shade for the second lighting unit shown FIG. 1a and FIG. 1b, and FIG. 3b shows the shade in a front view from an arrow shown in FIG. 3a.

The shade 23 can include: a first top reflex surface 23a1 that is located in a horizontal direction of the headlight; a second top reflex surface 23a2 located in the horizontal direction, and a virtual extending surface thereof that is located under the first top reflex surface 23a1 so as to be substantially parallel with the first top surface 23a1; a third reflex surface 23a3 located between the first top reflex surface 23a1 and the second reflex surface 23a2; and a top edge e2 located at an end of the top reflex surface 23a towards the projector lens 11.

The top edge e2 of the top reflex surface 23a of the shade 23 can include: a first top edge line e2a located at an end of the first top reflex surface 23a1 towards the projector lens 11, which can be configured to form a horizontal cut-off line for an oncoming lane; a second top edge line e2c located at an end of the second top reflex surface 23a2, and configured to form a horizontal cut-off line on a driving lane; and a third top edge line e2b located at an end of the third top reflex surface 23a3, and configured to form an elbow line between the first and second top reflex surfaces 23a1, 23a2.

In this case, the top edge e2 can be formed in a substantially circular arc shape towards the projector lens 21 in a top view of the shade 23, and can be configured to form a horizontal cut-off line. In addition, a convex shading portion 23b can be provided on the first top reflex surface 23a1 and along the first top edge line e2a so as not to project from the first top edge line e2a in a direction opposite to the arrow shown in FIG. 3a (i.e., in a horizontal planar direction). The convex shading portion 23b can form a cut-off line CL2a′ on a prescribed area A including a specific point (for example, the above-described 50R) in the light distribution pattern P2 as shown in FIG. 4.

The shade 23 can include the convex shading portion 23b on the first top reflex surface 23a1 in order to shield light emitted from the LED light source 22 on the prescribed area A including the 50 R point in the light distribution pattern P2 shown in FIG. 4. A width of the convex shading portion 23b can be configured to include a variation in a horizontal direction of the vehicle headlight, and also a height of the convex shading portion 23b can be configured to include a variation α in a vertical direction of an assembly for the vehicle headlight including the first and second lighting units.

Therefore, even when assembly variation for the first and second lighting units 10, 20 increases, the convex shading portion 23b can shield light emitted from the LED light source 22 so that the second lighting unit 20 is prevented from projecting light on the prescribed area A including the 50 R point in the light distribution pattern P2. In this case, α can be a maximum error (degrees) in a vertical direction of the vehicle headlight for the assembly of the first and second lighting units 10, 20.

The reason why the shade 23 includes the convex shade portion 23b is that the second lighting unit 20 enables the shade 23 to shield light on the prescribed area A including 50 R point in the light distribution pattern P2 while the first lighting unit 10 projects light on the prescribed area A. That is to say, after the vehicle headlight is attached to the vehicle so that the first lighting unit 10 can form the light distribution pattern P1 including the prescribed area A, the second lighting unit 20 can be attached to the vehicle headlight. Therefore, even when there is assembly variation for the second lighting unit 20, the second lighting unit 20 can prevent light from being projected on the prescribed area A including the specific point.

In addition, the first lighting unit 10 can form the horizontal cut-off line CL1a on an oncoming lane, for example, so that the cut-off line CL1a corresponds to a line of 0.57 degrees downwards from the horizontal line H that is established in a light distribution standard for a headlight. Accordingly, the second lighting unit 20 can be configured to prevent light from being projected over the horizontal cut-off line CL1a, and can form a horizontal cut-off line CL2b on a driving lane along with the cut-off line CL1b that is formed by the first lighting unit 10.

In this case, the third top reflex surface 23a3 can be determined, for example, so that the third top edge line e2b for forming the elbow line has a slant angle of 45 degrees with respect to the horizontal line H. In the above-described structure of the second lighting unit 20 including the shade 23, light emitted from the LED light source 22 can be reflected on the reflector 24 and can concentrate at the top edge e2 as shown in FIG. 1b. Ray 1 passing through the top edge e2 and Ray 2 being reflected at the top edge e2 including a fourth top edge line e2a′ can form a horizontal cut-off line CL2a including a cut-off line CL2a′, CL2b and CL2c in the light distribution pattern P2 having a wide range as shown in FIG. 4.

A method for forming a light distribution pattern having a wide range will now be given with reference to the above-described structure. When the reflector 24 includes a first focus located at the LED light source 22 and a second focus thereof located at the focus F of the projector lens 21, light emitted from the LED light source 22 may be subject to a concentration at the focus F of the project lens 21. Therefore, the light emitted from the LED light source 22 may concentrate near the vertical line V under the horizontal line H, because the top edge e2 of the shade 23 is located near the focus F of the projector lens 21.

As disclosed in patent document No. 2 (Japanese patent No. 2,696,745), the reflector 24 can be configured so that the second focus of the reflector 24 can widely correspond to the second top edge line e2c and a virtual extending line of the second top edge line e2c, which corresponds to a focus curve of the projector lens 21. In this case, the reflector 24 can be configured with one reflector including a plurality of surfaces, and also can be configured with a plurality of reflectors. Thereby, the light emitted from the LED light source 22 can be emitted with a wide range from the projector lens 21 because the second focus of the reflector 24 extends in the horizontal direction of the vehicle headlight.

According to the disclosed subject matter, because the second lighting unit 20 need not project light on the prescribed area A, the first lighting unit 10 can project only the light distribution pattern P1 on the prescribed area A in the light distribution pattern P for the vehicle headlight. Therefore, a light intensity of the light distribution pattern P1 can conform to a maximum light intensity value of the prescribed area A without decreasing the light intensity of the light distribution pattern P1.

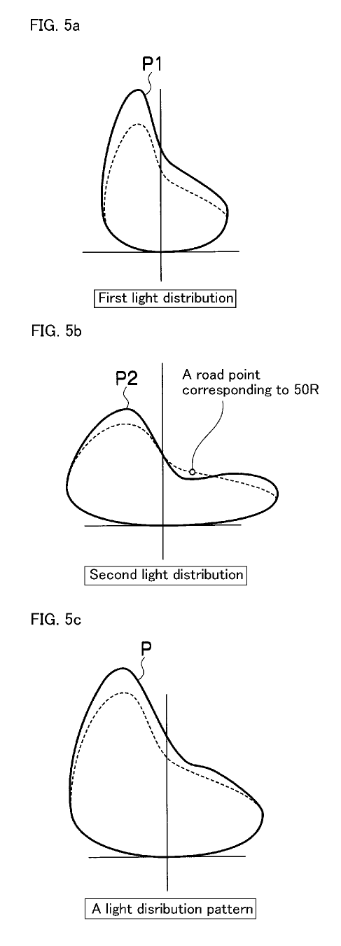

Moreover, because the lighting unit 20 need not project light distribution pattern P2 on the prescribed area A, the lighting unit 20 can form the distribution pattern P2 with high brightness within the range of a light distribution standard. FIG. 5a is a schematic diagram showing the light distribution pattern P1 formed on a road by the first lighting unit 10. FIG. 5b is a schematic diagram showing the light distribution pattern P2 formed on a road by the second lighting unit 20. FIG. 5c shows the light distribution pattern P on a road formed by the vehicle headlight of FIG. 1a, wherein broken lines show light distribution patterns that are formed by a conventional structure for a vehicle headlight.

The light intensity at the 50 R point on the light distribution pattern P1 can be adjusted at the maximum light intensity value of the 50 R point. Therefore, the light distribution pattern P1 can improve faraway visibility as compared to the light distribution line for conventional structure as shown in FIG. 5a. In addition, the light distribution pattern P2 can also improve the visibility with a wide range as shown in FIG. 5b. Thus, the vehicle headlight can perform a favorable light distribution pattern P by the first and second lighting units 10, 20 as shown in FIG. 5c while conforming to the light intensity range of the 50 R point.

In the above-described embodiment, a case in which vehicles drive on the left of a roadway is described with reference to the 50 point of ECE regulation. When vehicles drive on the right side of a roadway, the above-described structure of the vehicle headlight can be employed by incorporating bilaterally symmetric shades with respect to the shades 13 and 23. In this case, the disclosed subject matter can provide a vehicle headlight that can conform to another specific point (0.86 D-3.5 L: 1,800 cd to 12,000 cd) that is established in the United State as well as the 50 R point of ECE regulation.

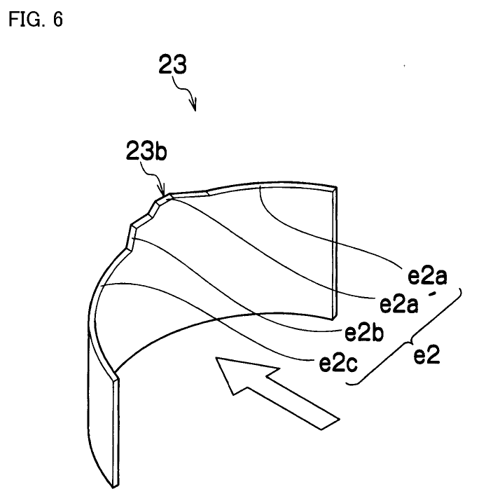

In addition, the embodiment using the shades 13 and 23 having the top reflex surfaces is described. However, the disclosed subject matter should not be limited to shades 13 and 23. FIG. 6 is a perspective enlarged view depicting another exemplary shade for the second lighting unit. Thin shades without the top reflex surface can also be used as the shades 13 and 23.

An exemplary assembly for the first and second lighting units 10, 20 will now be given with reference to the structure based upon the first lighting unit 10. The projector lens 11 and the shade 13 can be attached to a housing so that the neutral point of the shade 13 can be located substantially at the focus F of the projector lens 11, and so that the top edge e1 can be substantially bilaterally symmetric with respect to the optical axis of the projector lens 11 in the top view of the shade 13.

At least one ellipsoidal reflector having the first focus and the second focus can be attached to the heat sink H so that the first focus thereof can be located substantially at the LED light source 12, which is mounted on the top surface H1 of the heat sink H. The at least one ellipsoidal reflector can be attached to the housing along with the heat sink H and projector lens 11 so that the optical axis of the LED light source 12 can intersect with an imaginary line of the projector lens 11 that connects the first and second focuses of the ellipsoidal reflector to the optical axis of the projector lens 11, substantially at the first focus of at least the ellipsoidal reflector so as to corresponds to each other in a vertical direction.

In this case, when an intersecting angle of the optical axis of the LED light source 12 and the imaginary line of the projector lens 11 towards the at least one ellipsoidal reflector can be smaller than the intersecting angle towards the projector lens 11, because a strong light near the optical axis of the LED light source 12 can be reflected on a rearward part of the reflex surface that is located on the opposite side of the projector lens 11, the first lighting units 10 can improve a faraway visibility.

In addition, second focuses of other ellipsoidal reflectors other than at least the ellipsoidal reflector can be located substantially on the second top edge line e1c of the shade 13 and the virtual extending line of the second top edge line e1c. Thereby, the first lighting unit 10 may not concentrate light emitted from the LED light source 12 at a central portion of the horizontal cut-off line, and can form a favorable light distribution pattern with a wide range.

However, the above-described structure may make it difficult to control light between the first top edge line e1a and the virtual extending line of the second top edge line e1c, although such an ellipsoidal reflector may be easy to design and make. In addition, the structure may waste light in some cases because the second focuses of the ellipsoidal reflectors are located on the virtual extending line of the second top edge line e1c, which is located under the first top edge line e1a.

Consequently, the second focuses of the other ellipsoidal reflectors other than at least the ellipsoidal reflector can be located substantially on the first top edge line e1a of the shade 13 and the second top edge line e1c. In this case, the projector headlight 10 can provide a favorable light distribution pattern having a wide range, high brightness, and a high efficiency due to high light use efficiency. Thus, the disclosed subject matter can provide a small projector headlight using the LED light source having low power consumption and a high efficiency, which can be employed for vehicles, such as an electric car and the like.

Various modifications of the above disclosed embodiments can be made without departing from the spirit and scope of the presently disclosed subject matter. For example, in the above-described embodiment, the structure using a pair of first and second lighting units is described. However, each of the first lighting unit 10 and the second lighting unit 20 should not be limited to the a single lighting unit. A plurality of lighting units can be used in each of the first and second lighting units 10 and 20.

While there has been described what are at present considered to be exemplary embodiments of the invention, it will be understood that various modifications may be made thereto, and it is intended that the appended claims cover such modifications as fall within the true spirit and scope of the invention. All conventional art references described above are herein incorporated in their entirety by reference.

What is claimed is:

1. A projector headlight, comprising:
at least one first lighting unit and at least one second lighting unit located adjacent to each other, each of the at least one first lighting unit and the at least one second lighting unit including an LED light source, at least one ellipsoidal reflector, a projector lens and a shade, wherein
the ellipsoidal reflector has a first focus and a second focus, and the first focus is located substantially at the light source,
the projector lens has both a focus curve including a focus and an optical axis that is located substantially on an imaginary line connecting the first focus and the second focus of the ellipsoidal reflector, and the focus of the projector lens being located substantially at the second focus of the ellipsoidal reflector, and
the shade has a first top edge line, a second top edge line, a third top edge line and a neutral point, the first top edge line located upwards in a vertical direction of the projector headlight than a virtual extending line of the second top edge line and the third top edge line is located between the first top edge line and the second top edge line, the neutral point being an intersection of the virtual extending line of the second top edge line and another virtual line that passes at an intersection of the first top edge line and the third top edge line while intersecting with the virtual extending line of the second top edge line at a right angle, and the neutral point located substantially at the focus of the projector lens and configured to form a horizontal cut-off line for both a driving lane and an oncoming lane with light emitted from the light source, and wherein the third top edge line of the at least one second lighting unit further includes a fourth top edge line on the third top edge line.

2. The projector headlight according to claim 1, wherein the fourth top edge line of the at least one second lighting unit shields light emitted from the LED light source from a prescribed area including one point located 0.86 degrees downwards in a vertical direction of the projector headlight with respect to a horizontal line and 3.43 degrees towards the oncoming lane in a horizontal direction of the projector headlight with respect to a vertical line, and 0.86 degrees downwards in the vertical direction of the projector headlight with respect to the horizontal line and 3.5 degrees towards the oncoming lane in the horizontal direction of the projector headlight with respect to the vertical line.

3. The projector headlight according to claim 1, wherein the focus curve of the projector lens of the at least one first lighting unit corresponds substantially to the second top edge line and the virtual extending line of the second top edge line of the at least one first lighting unit, and the focus curve of the projector lens of the at least one second lighting unit corresponds substantially to the second top edge line and the virtual extending line of the second top edge line of the at least one second lighting unit.

4. The projector headlight according to claim 2, wherein the focus curve of the projector lens of the at least one first lighting unit corresponds substantially to the second top edge line and the virtual extending line of the second top edge lines of the at least one first lighting unit, and the focus curve of the projector lens of the at least one second lighting unit corresponds substantially to the second top edge line and the virtual extending line of the second top edge line of the at least one second lighting unit.

5. The projector headlight according to claim 1, further comprising other ellipsoidal reflectors, and wherein each second focus of each of the other ellipsoidal reflectors of the at least one first lighting unit is located substantially on at least one of the second top edge line of the shade and the virtual extending line of the second top edge line located under the first top edge line of the at least one first lighting unit, and each second focus of each of the other ellipsoidal reflectors of the at least one second lighting unit is located substantially on at least one of the second top edge line of the shade and the virtual extending line located under the first top edge line of the second top edge line of the at least one second lighting unit.

6. The projector headlight according to claim 2, further comprising other ellipsoidal reflectors, and wherein each second focus of the other ellipsoidal reflectors of the at least one first lighting unit is located substantially on at least one of the second top edge line of the shade and the virtual extending line of the second top edge line located under the first top edge line of the at least one first lighting unit, and each second focus of the other ellipsoidal reflectors of the at least one second lighting unit is located substantially on at least one of the second top edge line of the shade and the virtual extending line of the second top edge line located under the first top edge line of the at least one second lighting unit.

7. The projector headlight according to claim 3, further comprising other ellipsoidal reflectors, and wherein each second focus of the other ellipsoidal reflectors of the at least one first lighting unit is located substantially on at least one of the second top edge line of the shade and the virtual extending line of the second top edge line located under the first top edge line of the at least one first lighting unit, and each second focus of the other ellipsoidal reflectors of the at least one second lighting unit is located substantially on at least one of the second top edge line of the shade and the virtual extending line located under the first top edge line of the second top edge line of the at least one second lighting unit.

8. The projector headlight according to claim 4, further comprising other ellipsoidal reflectors, and wherein each second focus of the other ellipsoidal reflectors of the at least one first lighting unit is located substantially on at least one of the second top edge line of the shade and the virtual extending line of the second top edge line located under the first top edge line of the at least one first lighting unit, and each second focus of the other ellipsoidal reflectors of the at least one second lighting unit is located substantially on at least one of the second top edge line of the shade and the virtual extending line of the second top edge line located under the first top edge line of the at least one second lighting unit.

9. A projector headlight, comprising:
at least one first lighting unit and at least one second lighting unit located adjacent to each other, each of the at least one first lighting unit and the at least one second lighting unit including
an LED light source, a heat sink, at least one ellipsoidal reflector, a projector lens, a shade and a housing, wherein
the LED light source has an optical axis and is connected to the heat sink, the at least one ellipsoidal reflector has a first focus and a second focus, and is connected to the heat sink so that the first focus of the at least one ellipsoidal reflector is located substantially at the LED light source;
the projector lens has both a focus curve including a focus and an optical axis that is located substantially on an imaginary line connecting the first focus and the second focus of the at least one the ellipsoidal reflector, and the focus of the projector lens is located substantially at the second focus of the at least one ellipsoidal reflector,
the shade having a first top edge line, a second top edge line, a third top edge line and a neutral point, the first top edge line located further upwards in a vertical direction of the projector headlight as compared to a virtual extending line of the second top edge line and the third top edge line is located between the first top edge line and the second top edge line, the focus curve of the projector lens substantially corresponding with the second top edge line and the virtual extending line of the second top edge line, the neutral point being an intersection of the virtual extending line of the second top edge line and another virtual line that passes at an intersection of the first top edge line and the third top edge line while intersecting with the virtual extending line of the second top edge line at a right angle, the neutral point located substantially at the focus of the projector lens and configured to form a horizontal cut-off line for both a driving lane and an oncoming lane with light emitted from the light source, wherein the third top edge line of the at least one second lighting unit further includes a fourth top edge line on the third top edge line, and
the housing connects the projector lens, the shade and the at least one ellipsoidal reflector, and the optical axis of the LED light source intersects with the imaginary line of the projector lens substantially at the first focus of the at least one ellipsoidal reflector.

10. The projector headlight according to claim 9, wherein the fourth top edge line of the at least one second lighting unit shields light emitted from the LED light source from a prescribed area including one point located 0.86 degrees downwards in a vertical direction of the projector headlight with respect to a horizontal line and 3.43 degrees towards the oncoming lane in a horizontal direction of the projector headlight with respect to a vertical line, and 0.86 degrees downwards in the vertical direction of the projector headlight with respect to the horizontal line and 3.5 degrees towards the oncoming lane in the horizontal direction of the projector headlight with respect to the vertical line.

11. The projector headlight according to claim 9, wherein an intersecting angle of the optical axis of the LED light source and the imaginary line of the projector lens towards the at least one ellipsoidal reflector is smaller than the intersecting angle towards the projector lens.

12. The projector headlight according to claim 10, wherein an intersecting angle of the optical axis of the LED light source and the imaginary line of the projector lens towards the at least one ellipsoidal reflector is smaller than the intersecting angle towards the projector lens.

13. The projector headlight according to claim 9, further comprising other ellipsoidal reflectors, and each second focus of the other ellipsoidal reflectors of the at least one first lighting unit is located substantially on at least one of the second top edge line of the shade and the virtual extending line of the second top edge line located under the first top edge line of the at least one first lighting unit, and each second focus of the other ellipsoidal reflectors of the at least one second lighting unit is located substantially on at least one of the second top edge line of the shade and the virtual extending line of the second top edge line located under the first top edge line of the at least one second lighting unit.

14. The projector headlight according to claim 10, further comprising other ellipsoidal reflectors, and each second focus of the other ellipsoidal reflectors of the at least one first lighting unit is located substantially on at least one of the second top edge line of the shade and the virtual extending line of the second top edge line located under the first top edge line of the at least one first lighting unit, and each second focus of the other ellipsoidal reflectors of the at least one second lighting unit is located substantially on at least one of the second top edge line of the shade and the virtual extending line of the second top edge line located under the first top edge line of the at least one second lighting unit.

15. The projector headlight according to claim 11, further comprising other ellipsoidal reflectors, and wherein each second focus of the other ellipsoidal reflectors of the at least one first lighting unit is located substantially on at least one of the second top edge line of the shade and the virtual extending line of the second top edge line located under the first top edge line of the at least one first lighting unit, and each second focus of the other ellipsoidal reflectors of the at least one second lighting unit is located substantially on at least one of the second top edge line of the shade and the virtual extending line of the second top edge line located under the first top edge line of the at least one second lighting unit.

16. The projector headlight according to claim 12, further comprising other ellipsoidal reflectors, and wherein each second focus of the other ellipsoidal reflectors of the at least one first lighting unit is located substantially on at least one of the second top edge line of the shade and the virtual extending line of the second top edge line located under the first top edge line of the at least one first lighting unit, and each second focus of the other ellipsoidal reflectors of the at least one second lighting unit is located substantially on at least one of the second top edge line of the shade and the virtual extending line of the second top edge line located under the first top edge line of the at least one second lighting unit.

17. The projector headlight according to claim 9, further comprising other ellipsoidal reflectors, and wherein each second focus of the other ellipsoidal reflectors of the at least one first lighting unit is located substantially on at least one of the first top edge line and the second top edge line of the shade of the at least one first lighting unit, and each second focus of the other ellipsoidal reflectors of the at least one second lighting unit is located substantially on at least one of the first top edge line and the second top edge line of the shade of the at least one second lighting unit.

18. The projector headlight according to claim 10, further comprising other ellipsoidal reflectors, and wherein each second focus of the other ellipsoidal reflectors of the at least one first lighting unit is located substantially on at least one of the first top edge line and the second top edge line of the shade of the at least one first lighting unit, and each second focus of the other ellipsoidal reflectors of the at least one second lighting unit is located substantially on at least one of the first top edge line and the second top edge line of the shade of the at least one second lighting unit.

19. The projector headlight according to claim 11, further comprising other ellipsoidal reflectors, and wherein each second focus of the other ellipsoidal reflectors of the at least one first lighting unit is located substantially on at least one of the first top edge line and the second top edge line of the shade of the at least one first lighting unit, and each second focus of the other ellipsoidal reflectors of the at least one second lighting unit is located substantially on at least one of the first top edge line and the second top edge line of the shade of the at least one second lighting unit.

20. The projector headlight according to claim 12, further comprising other ellipsoidal reflectors, and wherein each second focus of the other ellipsoidal reflectors of the at least one first lighting unit is located substantially on at least one of the first top edge line and the second top edge line of the shade of the at least one first lighting unit, and each second focus of the other ellipsoidal reflectors of the at least one second lighting unit is located substantially on at least one of the first top edge line and the second top edge line of the shade of the at least one second lighting unit.
